(19) United States
(12) Patent Application Publication
(10) Pub. No.: US 2021/0323248 A1
(43) Pub. Date: Oct. 21, 2021

(54) Robotic Deposition of Pre-Preg Patches

(71) Applicant: Arevo, Inc., Milpitas, CA (US)

(72) Inventor: Leonid Michael Treyger, Orlando, FL (US)

(73) Assignee: Arevo, Inc., Milpitas, CA (US)

(21) Appl. No.: 16/853,737

(22) Filed: Apr. 20, 2020

(51) Int. Cl. B29C 70/38

(52) U.S. Cl. CPC B29C 70/388

(57) ABSTRACT

A robot is disclosed that deposits pre-preg patches. The end effector of the robot comprises a source of light that is characterized by a wavelength λ; a plenum comprising a plurality of thru-holes and a plurality of gas shafts, wherein each of the plurality of thru-holes comprises a first opening and a second opening, and wherein each of the plurality of thru-holes intersects at least one of the plurality of gas shafts; a hermetic window that: (i) is substantially transparent to light characterized by the wavelength λ, and (ii) substantially prevents the gas from flowing through the first opening of the each of the plurality of thru-holes; and an optical instrument that directs the light from the source through the hermetic window, through the first opening of each of the plurality of thru-holes, and through the second opening of each of the plurality of thru-holes.

### CROSS REFERENCE TO RELATED APPLICATIONS

This application is related to U.S. Ser. No. 16/792,150, entitled “Thermoplastic Mold with Tunable Adhesion,” filed on Feb. 14, 2020 (Attorney Docket: 3019-243us1), which application is incorporated by reference.

This application is related to U.S. Ser. No. 16/792,156, entitled “Thermoplastic Mold with Implicit Registration,” filed on Feb. 14, 2020 (Attorney Docket: 3019-245us1), which application is incorporated by reference.

### FIELD OF THE INVENTION

The present invention relates to additive manufacturing in general, and, more particularly, to additive manufacturing processes that use patches of fiber-reinforced thermoplastic fabric as the fundamental unit of printing.

### BACKGROUND OF THE INVENTION

In the same way that a building can be constructed by successively depositing bricks on top of one another, it is well known in the field of additive manufacturing that an article of manufacture can be printed by successively depositing patches of fiber-reinforced thermoplastic resin on top of one another. A piece of fabric that is pre-impregnated with a thermoplastic is commonly called a “pre-preg patch.”

In some ways, a pre-preg patch is similar to a lasagna noodle. When the temperature of the pre-preg patch is below its resin softening point, the pre-preg patch is stiff and not tacky—like a dry lasagna noodle. In contrast, when the temperature of the pre-preg patch is above its resin-softening point but below its melting point, the pre-preg patch is flexible and sticky—like a wet lasagna noodle.

There are, however, some key differences between bricks and pre-preg patches. First, most bricks in a building are the same size. In contrast, pre-preg patches are typically custom cut with a knife, die, or laser, and there can be a wide disparity in their shape and size. Second, bricks do not adhere to each other, and, therefore an adhesive compound—typically mortar—is used to bind them together. In contrast, pre-preg patches will weld to each other when they are heated above their resin softening point and pressed together until they cool. Third, bricks are not flexible but pre-preg patches are flexible and can be draped—with or without darts—into many contours.

Pre-preg patches are can be picked up and deposited manually—often in a mold—and heated with a heat gun or in an autoclave. This is, however, labor intensive and slow. Alternatively, a machine (i.e., a robot) can pick up, heat, and deposit successive pre-preg patches, which uses less labor and avoids the necessity of an autoclave. There are many advantages to using a machine but there are many challenges too.

### SUMMARY OF THE INVENTION

Some embodiments of the present invention are capable of depositing pre-preg patches without some of the costs and disadvantages for doing so in the prior art.

For example, one machine in the prior art comprises an articulated robot with an iron-like deposition head as the robot's end effector. In other words, the end effector is similar to the iron that many people have at home for ironing clothes to remove wrinkles. The bottom surface of the deposition head comprises a metal plate that is heated above the resin softening point of the thermoplastic in the patches. Because the metal plate contacts the pre-preg patches, the patches are themselves heated to above the resin softening point (mostly via thermal conduction). Depositing the pre-preg patches this way is problematic, however, because the patches tend to stick to the metal plate rather than to the surface where they are to be deposited.

The illustrative embodiment of the present invention obviates this problem by heating the pre-preg patch and not directly or intentionally heating the deposition head. This enables the pre-preg patch to be heated above its resin softening point but without creating a tendency for the patch to stick to the deposition head.

The illustrative embodiment comprises a source of light that is characterized by a wavelength λ; a plenum comprising a plurality of thru-holes and a plurality of gas shafts, wherein each of the plurality of thru-holes comprises a first opening and a second opening, and wherein each of the plurality of thru-holes intersects at least one of the plurality of gas shafts; a hermetic window that:
(i) is substantially transparent to light characterized by the wavelength λ, and
(ii) substantially prevents the gas from flowing through the first opening of the each of the plurality of thru-holes; and
   an optical instrument that directs the light from the source through the hermetic window, through the first opening of each of the plurality of thru-holes, and through the second opening of each of the plurality of thru-holes.

This enables the machine to pick up a pre-preg patch using suction, to heat the pre-preg patch using light from the source, and deposit the patch using pressurized gas, all while keeping the plenum cool.

Some embodiments of the present invention can be used with patches of fiber-reinforced UV-curable thermosets when the light source emits UV light (i.e., 157 nm≤λ≤400 nm), and the hermetic window is substantially transparent to light at that wavelength.

### BRIEF DESCRIPTION OF THE DRAWINGS

FIG. 1 depicts a front orthographic illustration of the salient components of additive manufacturing system 100 in accordance with the illustrative embodiment of the present invention.

FIG. 2a depicts an orthographic front view of the salient features of deposition head 121 with the free-space paths of the light rays 211 employed by deposition head 121.

FIG. 2b depicts an orthographic top view of the salient features of deposition head 121 without the free-space paths of the light rays 211 employed by deposition head 121.

FIG. 2c depicts an orthographic side view of the salient features of deposition head 121 with the free-space paths of the light rays 211 employed by deposition head 121.

FIG. 3a depicts an orthographic front view of the salient features of plenum 203.

FIG. 3b depicts an orthographic top view of the salient features of plenum 203.

FIG. 3c depicts an orthographic bottom view of the salient features of plenum 203.

FIG. 3d depicts an orthographic side view of the salient features of plenum 203.

FIG. 4 depicts a flowchart of the salient tasks performed in accordance with the illustrative embodiment of the present invention.

FIG. 5 depicts an orthographic front view of the salient features of plenum 503 in accordance with an alternative embodiment of the present invention.

FIG. 6 depicts an orthographic top view of the salient features of plenum 603 in accordance with an alternative embodiment of the present invention.

FIG. 7 depicts an orthographic top view of the salient features of plenum 703 in accordance with an alternative embodiment of the present invention.

### DEFINITIONS

Pre-Preg Patch—For the purposes of this specification, a “pre-preg patch” and its inflected forms is defined as a piece of fabric that is pre-impregnated with a UV-curable thermoset or a thermoplastic.

Printer—For the purposes of this specification, a “printer” is defined as an additive manufacturing system or an additive and subtractive manufacturing system.

Printing—For the purposes of this specification, the infinitive “to print” and its inflected forms is defined as to fabricate. The act of fabrication is widely called “printing” in the field of additive manufacturing.

Resin Softening Point—For the purposes of this specification the phrase “resin softening point” is defined as the temperature at which the resin softens beyond some arbitrary softness.

### DETAILED DESCRIPTION

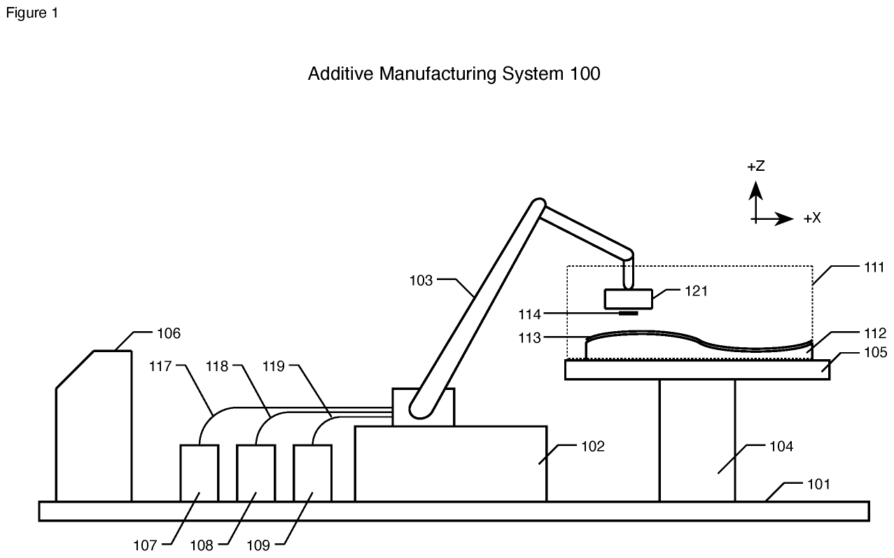

FIG. 1 depicts a front orthographic illustration of the salient components of additive manufacturing system 100 in accordance with the illustrative embodiment of the present invention. The purpose of additive manufacturing system 100 is to print (i.e., fabricate) an article of manufacturing by successively depositing pre-preg patches (i.e., patches of fabric that are pre-impregnated with thermoplastic resin) in a prescribed order and location.

Additive manufacturing system 100 comprises: platform 101, robot mount 102, robot arm 103, build plate support 104, build plate 105, controller 106, laser 107, vacuum 108, pump 109, build volume 111, mold 112, sheet of metal foil 113, pre-preg patch 114, optical fiber 117, vacuum hose 118, pneumatic hose 119, and deposition head 121.

Platform 101 is a rigid metal structure that ensures that the relative spatial relationship (i.e., location and position) of robot mount 102, robot arm 103, and deposition head 121 are knowable with respect to build-plate support 104, build plate 105, build volume 111, and mold 112. It will be clear to those skilled in the art how to make and use platform 101.

Robot mount 102 is a rigid, massive, and stable support for robot arm 103. It will be clear to those skilled in the art how to make and use robot mount 102.

Robot arm 103 comprises a six-axis articulated robot that is under the control of controller 106. A non-limiting example of robot arm 103 is the IRB 4600 robot offered by ABB Group of Stockholm, Sweden. Robot arm 103 holds:
(i) deposition head 121, and
(ii) fiber optic cable 117, which carries light from laser 107 to deposition head 121, and
(iii) vacuum hose 118, which carries a gas (mostly ambient air) from deposition head to vacuum 108, and
(iv) pneumatic hose 119, which carries a gas (e.g., air, nitrogen, etc.) from pump 109 to deposition head 121.

Robot arm 103 can—under the direction of controller 106—pick up pre-preg patch 114 with deposition head 121 (anywhere within its reach) and deposit pre-preg patch 114 (at any location within build volume 111 and from any approach angle). Although the illustrative embodiment uses an articulated robot, it will be clear to those skilled in the art, after reading this disclosure, how to make and use alternative embodiments of the present invention that comprise a gantry-style robot instead of, or in addition to, an articulated robot. In any case, it will be clear to those skilled in the art how to make and use robot arm 103.

Build plate support 104 is a rigid, massive, and stable support for build plate 105. Build plate support 104 comprises a stepper motor—that is under the control of controller 106—that is capable of rotating build plate 105 (and everything resting on build plate 105) around an axis that is normal to the X-Y plane. It will be clear to those skilled in the art how to make and use build plate support 104.

Build plate 105 is a rigid aluminum-alloy support onto which mold 112 is steadfastly affixed so that mold 112 (and everything resting or affixed to mold 112) cannot move or rotate independently of build plate 105. In accordance with the illustrative embodiment, the location and position of build plate 105 defines build volume 111 and the three-dimensional coordinate system for build volume 111. All spatial references for printing of the article of manufacture are specified in that coordinate system. If build plate 105 is moved (e.g., rotated, tilted, translated, etc.) by build plate support 104 then the coordinate system is moved as well. Build plate 105 is described in detail in U.S. Ser. No. 16/792,156, entitled “Thermoplastic Mold with Implicit Registration,” filed on Feb. 14, 2020 (Attorney Docket: 3019-245us1), which application is incorporated by reference.

Controller 106 comprises the hardware and software necessary to direct robot arm 103, build plate support 104, laser 107, vacuum 108, pump 109, and deposition head 121 in order to print an article of manufacture from patches of pre-preg. It will be clear to those skilled in the art how to make and use controller 106.

Laser 107 is hardware that is a source of high-power light that is transported via optical fiber 117 to deposition head 121. A non-limiting example of laser 107 is the Laserline diode laser model LDM 800-60, which radiates light characterized by the wavelength λ=980 nm and has a maximum power output of 800 Watts. It will be clear to those skilled in the art, after reading this disclosure, how to make and use alternative embodiments of the present invention that use light characterized by a different wavelength λ (e.g., 880 nm, 905 nm, 910 nm, 915 nm, 940 nm, 970 nm, 1020 nm, 1060 nm, etc.). Also, it will be clear to those skilled in the art, after reading this disclosure, how to make and use alternative embodiments of the present invention, that use a CW fiber laser which radiates light characterized by the wavelength λ=1060 nm.

The purpose of the light from laser 107 is to heat pre-preg patch 114 in preparation for deposition onto sheet of metal foil 113 (or onto one or more previously deposited patches of pre-preg.) In accordance with the illustrative embodiment, the intensity of laser 107—including turning it on and off—is under the control of controller 106. It will be clear to those skilled in the art, after reading this disclosure, how to make and use alternative embodiments of the present invention that use a different electromagnetic radiation source (e.g., a high-energy flash lamp that radiates over a wide range of frequencies, etc.). Furthermore, it will be clear to those skilled in the art how to determine the maximum power of the laser based on, for example, the mass of pre-preg patch 114, the surface area of pre-preg patch 114, the thermal characteristics of pre-preg patch 114, and the exposure time allocated for heating pre-preg patch 114, etc. It will be clear to those skilled in the art how to make and use laser 107.

Vacuum 108 is hardware under the control of controller 106 that provides suction at 1 kPa, via a vacuum hose, to deposition head 121. As explained in greater detail below and in the accompanying figures, plenum 203 uses the suction to grab and hold onto pre-preg patch 114. It will be clear to those skilled in the art, after reading this disclosure, how to make and use alternative embodiments of the present invention that employ a different pressure vacuum. It will be clear to those skilled in the art how to make and use vacuum 108.

Pump 109 is hardware under the control of controller 106 that provides a pressurized gas (e.g., air, nitrogen, an air-nitrogen mixture, etc.) at 100 kPa and 23° Celcius (but in no case hotter than the lower of 200° Celcius and the resin softening point of the thermoplastic in pre-preg patch 114), via a pneumatic hose, to deposition head 121. As explained in greater detail below and in the accompanying figures, plenum 203 uses the pressurized gas to detach pre-preg patch 114 from plenum 203 and to tamp pre-preg patch 114 down after it has been heated. Although the illustrative embodiment employs pressurized air at 100 kPa, it will be clear to those skilled in the art, after reading this disclosure, how to make and use alternative embodiments of the present invention that employ a different pressure. It will be clear to those skilled in the art how to make and use pump 109.

Build Volume 111 is the region in three-dimensional space in which robot arm 103 is capable of depositing and tamping pre-preg patch 114.

Mold 112 is a three-dimensional volume of thermoplastic (e.g., polycarbonate, PAEK, PEK, PAEK, PEEK, PEKK, PEEKK, PEKEKK, etc.) on which sheet of metal foil 113 is loosely affixed and which imparts a contour to one surface of the article of manufacture. Mold 112—and the welding of pre-preg patch 114 to mold 112 through sheet of metal foil 113—is described in detail in U.S. Ser. No. 16/792,156, entitled “Thermoplastic Mold with Implicit Registration,” filed on Feb. 14, 2020 (Attorney Docket: 3019-245us1), which application is incorporated by reference. Although that application explicitly teaches the deposition of carbon-reinforced thermoplastic filament rather than patches, it will be clear to those skilled in the art that the two are analogous and that the chemistry and materials science for the two is the same.

Sheet of metal foil 113 is, as the name suggests, a sheet of metal foil. Sheet of metal foil 113 is loosely affixed to mold 112 and pre-preg patch 121 is deposited onto sheet of metal foil 113. Sheet of metal foil 113 is described in detail in U.S. Ser. No. 16/792,150, entitled “Thermoplastic Mold with Tunable Adhesion,” filed on Feb. 14, 2020 (Attorney Docket: 3019-243us1), which application is incorporated by reference.

Pre-preg patch 114 is a piece of a continuous fiber-reinforced thermoplastic pre-preg that has been cut from a tape.

In accordance with the illustrative embodiment, pre-preg patch 114 comprises a 5.9 ounce 2×2 twill weave woven from 3K continuous carbon fibers and impregnated with PEEK.

It will be clear to those skilled in the art how to make and use alternative embodiments of the present invention in which pre-preg patch 114 comprises a different weight, a different weave, and/or is woven from different size tows of fibers (e.g., 1K, 3K, 6K, 24K, etc.).

Furthermore, it will be clear to those skilled in the art how to make and use alternative embodiments of the present invention in which the fibers comprise a different material (e.g., fiberglass, aramid, PBO (i.e., Zylon™), carbon nanotubes, stainless steel, Inconel (nickel/chrome), titanium, aluminum, cobalt chrome, copper, bronze, iron, precious metals (e.g., platinum, gold, silver, etc.).

And still furthermore, it will be clear to those skilled in the art how to make and use alternative embodiments of the present invention in which pre-preg patch 114 is impregnated with a different thermoplastic, such as, for example, a semi-crystalline polymer and, in particular, the polyaryletherketone (PAEK) known as polyetherketone (PEK). In accordance with some alternative embodiments of the present invention, the semi-crystalline material is the polyaryletherketone (PAEK), polyetheretherketone (PEEK), polyetherketoneketone (PEKK), polyetheretherketoneketone (PEEKK), or polyetherketoneetherketoneketone (PEKEKK).

In accordance with some alternative embodiments of the present invention, the semi-crystalline polymer is not a polyaryletherketone (PAEK) but another semi-crystalline thermoplastic (e.g., polyamide (PA), polybutylene terephthalate (PBT), poly(p-phenylene sulfide) (PPS), etc.) or a mixture of a semi-crystalline polymer and an amorphous polymer.

When the filament comprises a blend of an amorphous polymer with a semi-crystalline polymer, the semi-crystalline polymer can be one of the aforementioned materials and the amorphous polymer can be a polyarylsulfone, such as polysulfone (PSU), polyethersulfone (PESU), polyphenylsulfone (PPSU), polyethersulfone (PES), or polyetherimide (PEI). In some additional embodiments, the amorphous polymer can be, for example and without limitation, polyphenylene oxides (PPOs), acrylonitrile butadiene styrene (ABS), methyl methacrylate acrylonitrile butadiene styrene copolymer (ABSi), polystyrene (PS), or polycarbonate (PC).

When the filament comprises a blend of an amorphous polymer with a semi-crystalline polymer, the weight ratio of semi-crystalline material to amorphous material can be in the range of about 50:50 to about 95:05, inclusive, or about 50:50 to about 90:10, inclusive. Preferably, the weight ratio of semi-crystalline material to amorphous material in the blend is between 60:40 and 80:20, inclusive. The ratio selected for any particular application may vary primarily as a function of the materials used and the properties desired for the printed article.

In any case, it will be clear to those skilled in the art how to make and use pre-preg patch 114.

Optical fiber 117 is a flexible glass fiber that is capable of carrying the light from laser 107 to deposition head 121 with little loss. It will be clear to those skilled in the art how to make and use optical fiber 117.

Vacuum hose 118 is a flexible fiber-reinforced hose that will not collapse from the static vacuum created by vacuum 108 or the Bernoulli effect of moving gas within it. It will be clear to those skilled in the art how to make and use vacuum hose 118.

Pneumatic hose 119 is flexible fiber-reinforced hose that will not rupture from the static pressure created by pump 109 and will not collapse from the Bernoulli effect of moving gas within it. It will be clear to those skilled in the art how to make and use pneumatic hose 119.

Deposition head 121 constitutes the end effector of robot arm 103. As described in detail below and in the accompanying figures, the purpose of the deposition head is to:
(i) pick up pre-preg patch 121 using suction created by vacuum 108, and
(ii) heat pre-preg patch 121 using the light from laser 107, and
(iii) deposit and tamp pre-preg patch 121 using the pressurized gas from pump 109 and the underside of that plenum that most closely matches the contour of the location where pre-preg patch 121 is being deposited.

In particular, the interaction of pre-preg patch 114, sheet of metal foil 113, and mold 112 require that deposition head 121:
(i) directly heats (with radiation from laser 107) the carbon fibers in pre-preg patch 114, which in turn
(ii) indirectly heats (with thermal conduction from the carbon fibers) the thermoplastic in pre-preg patch 114, which in turn
(iii) indirectly heats (with thermal conduction from the reverse side of pre-preg patch 114) the obverse side of a region of sheet of metal foil 113, which in turn
(iv) indirectly heats (with thermal conduction from the reverse side of the region of sheet of metal foil 113) the obverse side of a region of mold 112.
   When pre-preg patch 114, the region of sheet of composite fibers 118, and the obverse side of the region of mold 112 are all heated above their resin softening point, the pressure of deposition head 121 facilitates the thermal welding of the reverse side of pre-preg patch 114 to the obverse side of the region of mold 112 through one of more of the thru-holes in sheet of metal foil 113. It will be clear to those skilled in the art, after reading this disclosure and the incorporated documents, how to make and use deposition head 121, mold 112, sheet of metal foil 113, and pre-preg patch 114.

In contrast, when pre-preg patch 114 is deposited onto previously pre-preg patches—rather than directly onto sheet of metal foil 113, deposition head 121:
(i) directly heats (with radiation from laser 107) the carbon fibers in pre-preg patch 114, which in turn
(ii) indirectly heats (with thermal conduction from the carbon fibers) the thermoplastic in pre-preg patch 114, and
(iii) directly heats (with radiation from laser 107) the carbon fibers in the previously-deposited pre-preg patches, which in turn
(iv) indirectly heats (with thermal conduction from thermoplastic in pre-preg patch 114 and with thermal conduction from the carbon fibers in the previously-deposited pre-preg patches) the thermoplastic in the previously-deposited pre-preg patches.
   When pre-preg patch 114, and the previously-deposited pre-preg patches are both heated above their resin softening point, the pressure of deposition head 121 facilitates the thermal welding of the reverse side of prep-preg patch 114 to the obverse side of the previously-deposited patch.

In some alternative embodiments of the present invention, the pre-preg patch to be deposited does not comprise fibers that absorbs light from laser 107. In these cases, pre-preg patch is substantially transparent to near infrared radiation. In these cases, deposition head 121:
(i) directly heats (with radiation from laser 107) the carbon fibers or other radiation absorbing material in the previously-deposited pre-preg patches or other substrate, which in turn
(ii) indirectly heats (with thermal conduction from the previously-deposited pre-preg patches or other substrate) the thermoplastic in the to-be-deposited pre-preg patch, and
(iii) indirectly heats (with thermal conduction from the previously-deposited pre-preg patches or other substrate) the thermoplastic in the previously-deposited pre-preg patch or substrate.

And in still some other alternative embodiments of the present invention in case of a partially transparent/partially absorbing patch and partially transparent/partially absorbing substrate or mold (e.g., PEEK or polycarbonate on wavelength 1.9 to 2.05 microns, etc.), heats and melts polymers in controlled melting on tightly controlled depth, therefore causing weld of the patch to the substrate.

Deposition head 121 is described in detail below and in the accompanying figures.

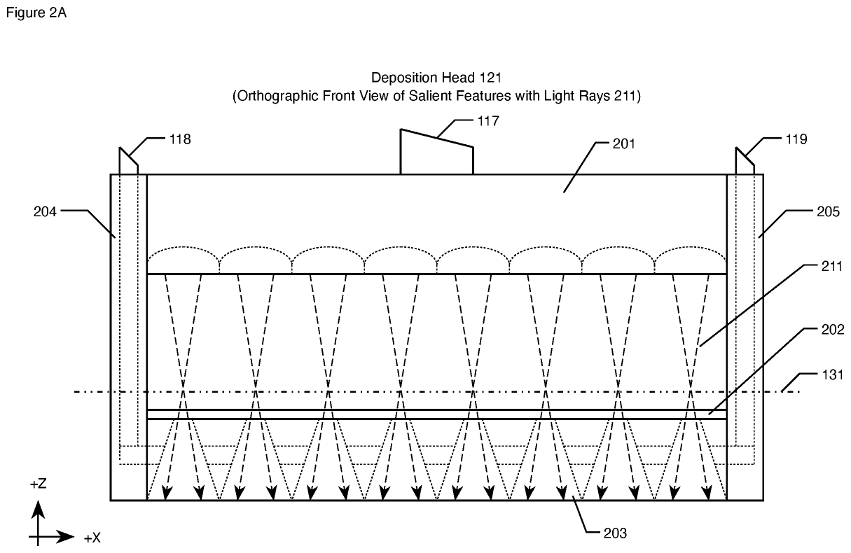

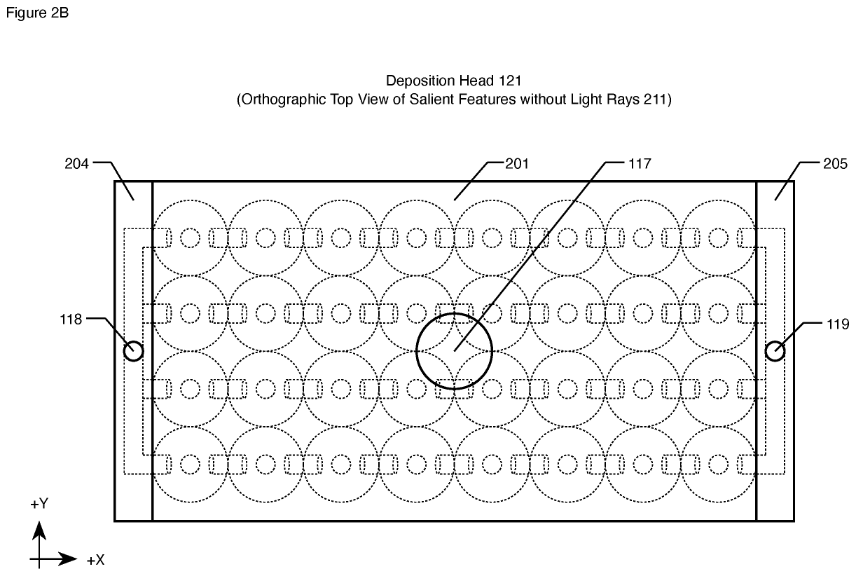

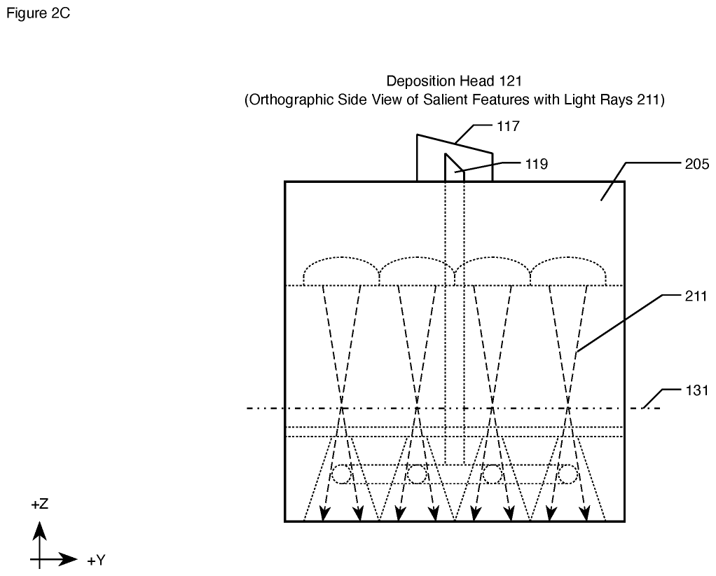

FIG. 2a depicts an orthographic front view of the salient features of deposition head 121 and the free-space paths of the light rays 211. FIG. 2b depicts an orthographic top view of the salient features of deposition head 121 without the free-space paths of the light rays 211 employed by deposition head 121. FIG. 2c depicts an orthographic side view of the salient features of deposition head 121 and the free-space paths of the light rays 211 employed by deposition head 121.

As shown in FIGS. 2a, 2b, and 2c, the salient sub-components of deposition head 121 are: optical instrument 201 (which is connected to one end of optical fiber 117), hermetic window 202, plenum 203, vacuum manifold 204 (which is connected to one end of vacuum hose 118), and pneumatic manifold 205 (which is connected to one end of pneumatic hose 119). Also depicted in FIGS. 2a and 2c is focal plane 131 of optical instrument 201 and the paths of representative light rays 211 through free space, through hermetic window 202, and through the thru-holes of plenum 203.

Optical instrument 201 is hardware that receives light from optical fiber 117 and directs it through hermetic window 202 and through the thru-holes in plenum 203 where it heats pre-preg patch 114. To accomplish this, optical instrument 201 comprises an array of microlenses—one microlense for each thru-hole in plenum 203. Because plenum 203 comprises an 8×4 orthogonal array of thru-holes, optical instrument 201 comprises an 8×4 orthogonal array of microlenses. It will be clear to those skilled in the art, after reading this disclosure, how to make and use alternative embodiments of the present invention in which optical instrument 201 comprises a different configuration (e.g., a different size orthogonal array of microlenses, a non-orthogonal array of microlenses, etc.). It will be clear to those skilled in the art how to make and use optical instrument 201.

Hermetic window 202 is a slab of fused-silica glass that is substantially transparent to light at 980 nm and that is strong enough to create a hermetic seal of the top openings of the thru-holes of plenum 203. In other words, the purpose of hermetic window 202 is to allow light to pass into the top openings of the thru-holes of plenum 203 while also preventing any gas from entering or exiting the top opening of the thru-holes.

In accordance with the illustrative embodiment, hermetic window 202 is made of fused silica, but it will be clear to those skilled in the art, after reading this disclosure, how to make and use alternative embodiments of the present invention in which a different material is used, so long as the material is substantially transparent to light characterized by the wavelength λ=980 nm (i.e., the electromagnetic wavelengths used to head pre-preg patch 114).

Furthermore, in accordance with the illustrative embodiment, hermetic window 202 is a single slab that covers all of the top of plenum 203, which includes both the solid portions and the tops of the thru-holes. It will be clear to those skilled in the art, after reading this disclosure, how to make and use alternative embodiments of the present invention in which each thru-hole comprises its own hermetic window, which might or might not be recessed below the top of plenum 203.

In any case, it will be clear to those skilled in the art how to make and use hermetic window 202.

Plenum 203 is a block of metal (e.g., steel, aluminum alloy, etc.) that tolerates the ambient heat and incidental radiation used to heat pre-preg patch 114. The purpose of plenum 203 is to provide thru-holes that—when combined with suction—can pick up pre-preg patch 114 and when combined with high-pressure gas can deposit and tamp pre-preg patch 114 and through which pre-preg patch 114 can be heated with the light from optical instrument 201. Plenum 203 is described in detail below and in the accompanying figures.

Vacuum manifold 204 is a block of metal (e.g., steel, aluminum alloy, etc.) that provides a manifold and flue to evacuate the gas from the thru-holes in plenum 203 via the gas shafts to vacuum hose 118. It will be clear to those skilled in the art how to make and use vacuum manifold 204.

Pneumatic manifold 205 is a block of metal (e.g., steel, aluminum alloy, etc.) that provides a manifold and pathway for the high-pressure gas from pneumatic hose 119 to the gas shafts that pressurize the thru-holes in plenum 203. It will be clear to those skilled in the art how to make and use pneumatic manifold 205.

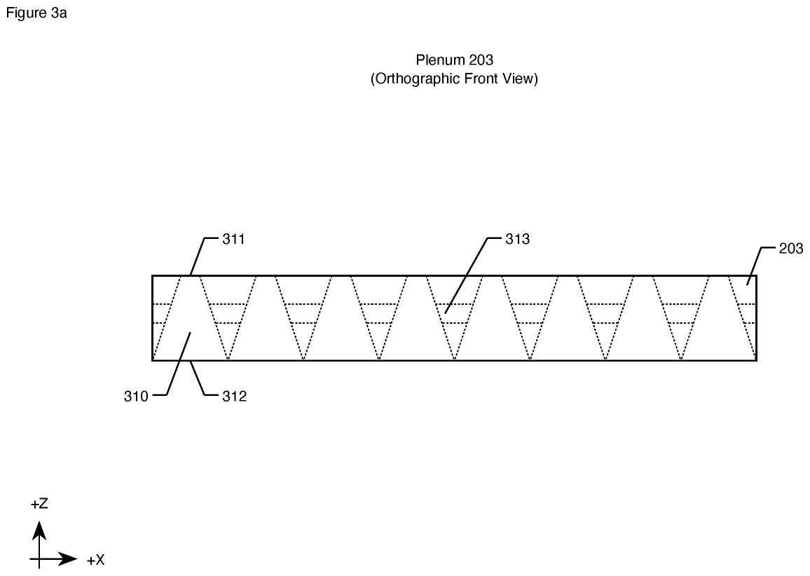

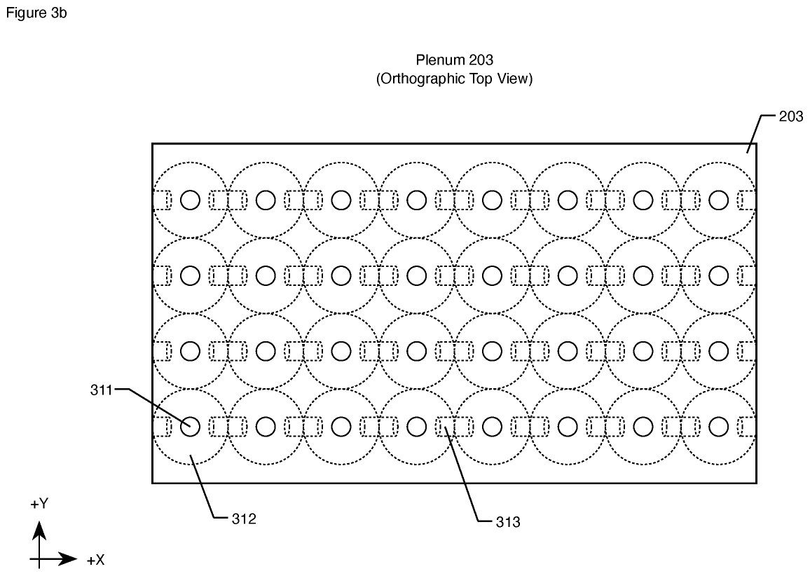

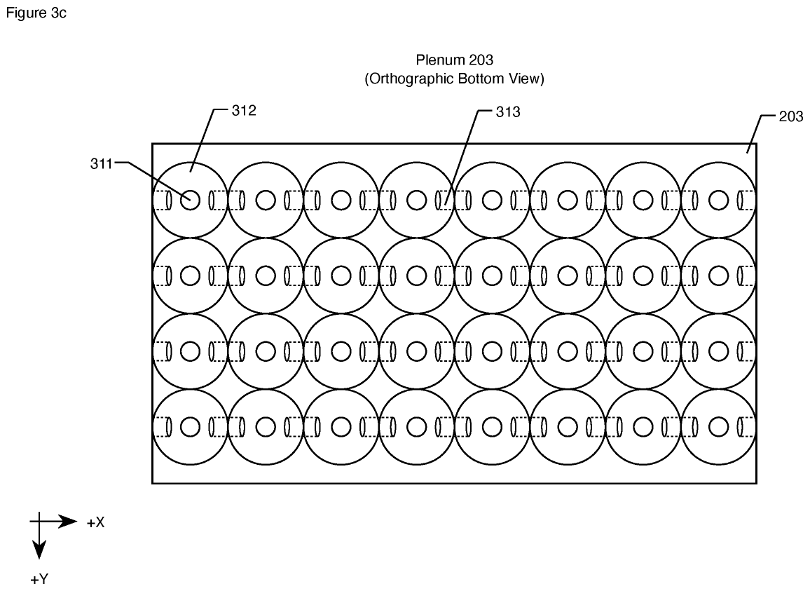

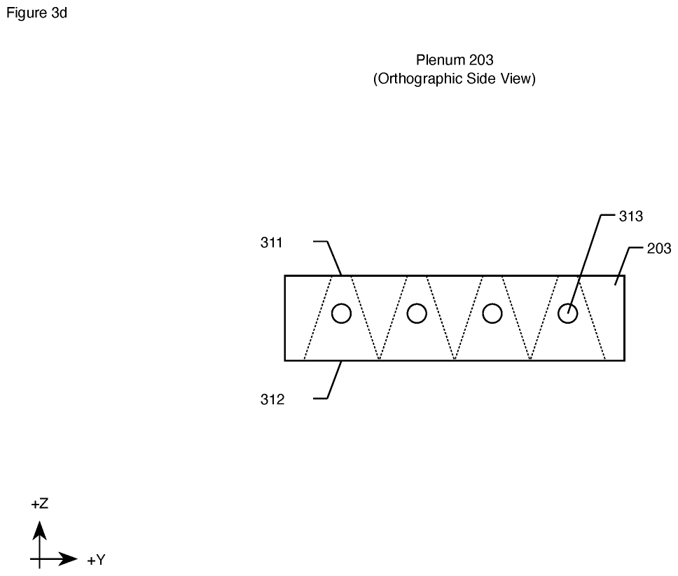

FIGS. 3a, 3b, 3c, and 3d depict orthographic front, top, bottom, and side views, respectively, of the salient features of plenum 203. As shown in FIGS. 3a, 3b, 3c, and 3d, plenum 203 comprises an 8×4 orthogonal array of identical thru-holes, such as thru-hole 310, which are interconnected as shown by gas shafts, such as gas shaft 313. Each thru-hole has the shape of a frustum of a right cone with the top of the thru-hole, such as top 311, adjacent to hermetic window 202, and the bottom of the thru-hole, such as based 312, adjacent to pre-preg patch 114.

In accordance with the illustrative embodiment, each thru-hole has a conical shape, but it will be clear to those skilled in the art, after reading this disclosure, how to make and use alternative embodiments of the present invention in which thru-hole has a different shape (e.g., cylindrical, prismatic, etc.). In accordance with the illustrative embodiment, plenum 203 comprises an orthogonal array of thru-holes, but it will be clear to those skilled in the art, after reading this disclosure, how to make and use alternative embodiments of the present invention in which plenum 203 comprises a different arrangement of thru-holes (e.g., hexagonal, irregular, etc.). In any case, it will be clear to those skilled in the art, after reading this disclosure, how to make and use plenum 203.

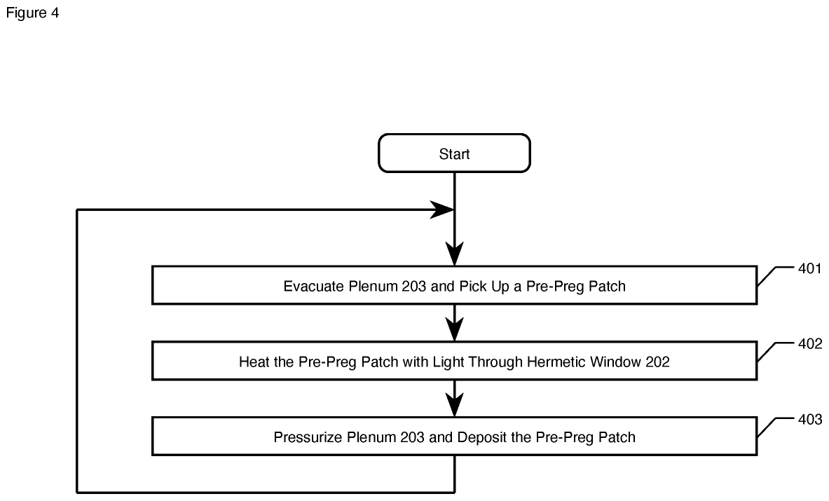

FIG. 4 depicts a flowchart of the salient tasks performed in accordance with the illustrative embodiment of the present invention.

At task 401, additive manufacturing system 100 picks up pre-preg patch 114 with plenum 203 by evacuating plenum 203 with vacuum 108. It will be clear to those skilled in the art, after reading this disclosure, how to enable additive manufacturing system 100 to perform task 401.

At task 402, additive manufacturing system 100 heats pre-preg patch 114 with the laser light through hermetic window 202 to above its resin softening point. It will be clear to those skilled in the art, after reading this disclosure, how to enable additive manufacturing system 100 to perform task 402.

At task 403, additive manufacturing system 100 deposits pre-preg patch 114 on sheet of metal foil 113 (or on top of another previously-deposited pre-preg patch) with plenum 203 by pressuring plenum 302 with air (or nitrogen) from pump 109. By applying sufficient force with robot arm 203 and sufficient air pressure, additive manufacturing system 100 welds pre-preg patch 114 to mold 112 through one or more of the holes in sheet of metal foil 113. It will be clear to those skilled in the art, after reading this disclosure, how to enable additive manufacturing system 100 to perform task 403.

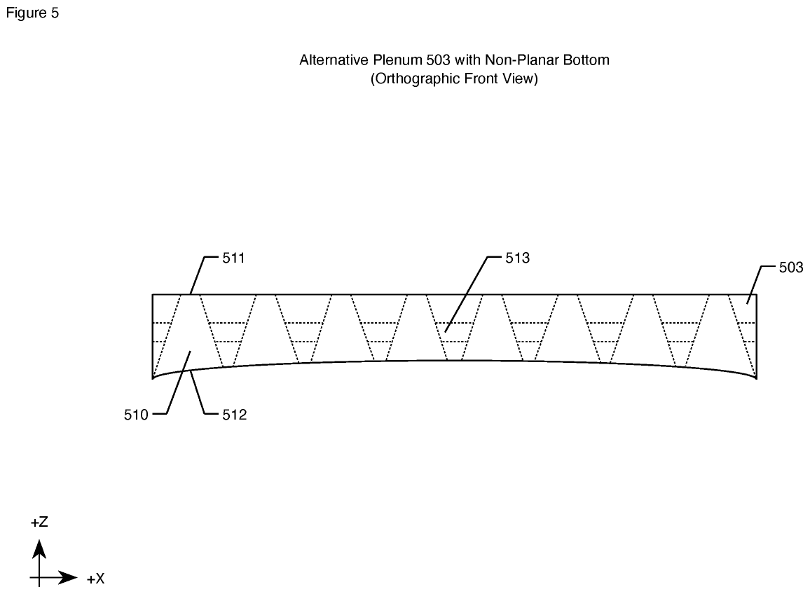

FIG. 5 depicts an orthographic front view of the salient features of plenum 503 in accordance with an alternative embodiment of the present invention. As shown in FIG. 5, the bottom of plenum 503 is, in general, non-planar, and, in particular, concave in one dimension. This is in contrast to the bottom of plenum 203, which is planar. Plenum 503 is, for example, advantageous when depositing pre-preg patches onto convex surfaces. It will be clear to those skilled in the art, after reading this disclosure, how to make and use alternative embodiments of the present invention in which the bottom has a contour (e.g., concave, convex, irregular, etc.) that matches the contour of the surface onto which a pre-preg patch is to be deposited.

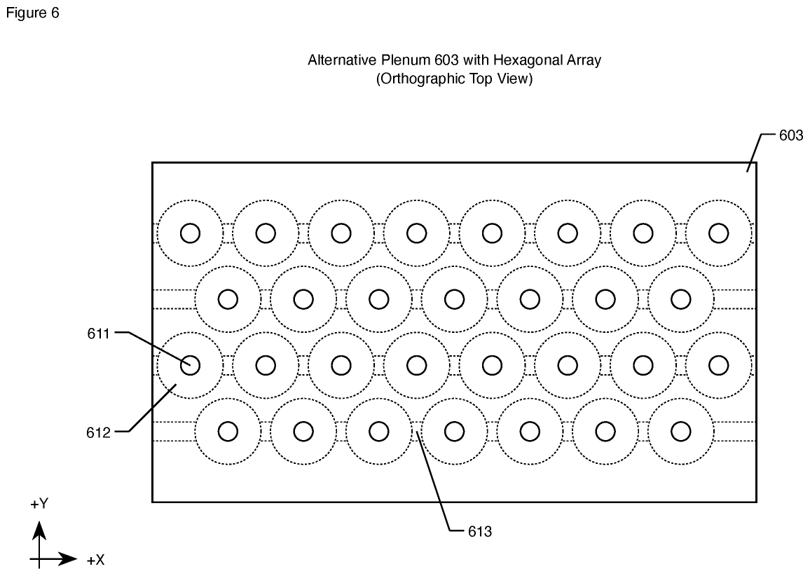

FIG. 6 depicts an orthographic top view of the salient features of plenum 603 in accordance with an alternative embodiment of the present invention. As shown in FIG. 6, the thru-holes in plenum 603 are arranged in a hexagonal array, which irradiates a greater percentage of a pre-preg patch than does an orthogonal array. It will be clear to those skilled in the art, after reading this disclosure, how to make and use alternative embodiments of the present invention in which the thru-holes are arranged in any pattern.

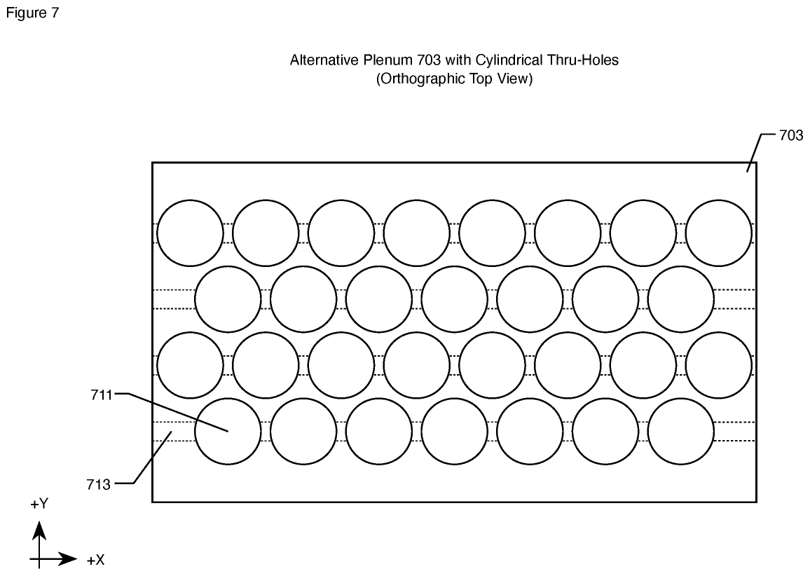

FIG. 7 depicts an orthographic top view of the salient features of plenum 703 in accordance with an alternative embodiment of the present invention. As shown in FIG. 7, the thru-holes in plenum 703 are cylindrical, which might be easier to fabricate than the conical thru-holes in plenum 203. It will be clear to those skilled in the art, after reading this disclosure, how to make and use alternative embodiments of the present invention in which the thru-holes have any profile.

What is claimed is:

1. A machine comprising:
a source of light that is characterized by a wavelength λ;
a plenum comprising a thru-hole and a gas shaft, wherein the thru-hole comprises a first opening and a second opening, and wherein the gas shaft intersects the thru-hole;
a hermetic window that:
(i) is substantially transparent to light characterized by the wavelength λ, and
(ii) substantially prevents the gas from flowing through the first opening of the thru-hole; and
an optical instrument that directs the light from the source through the hermetic window, through the first opening of the thru-hole, and through the second opening of the thru-hole.

2. The machine of claim 1 wherein the machine is configured to heat a patch of fabric that is impregnated with a thermoplastic, and
wherein the temperature of the plenum remains below the resin softening point of the thermoplastic.

3. The machine of claim 1 wherein the average temperature of the plenum is below 200° Celcius.

4. The machine of claim 1 further comprising:
a vacuum for evacuating, via the gas shaft, the thru-hole of the gas.

5. The machine of claim 1 further comprising:
a pump for pressurizing, via the gas shaft, the thru-hole with the gas.

6. The machine of claim 5 wherein the machine is configured to heat a patch of fabric that is impregnated with a thermoplastic, and
wherein the temperature of the gas is below the resin softening point of the thermoplastic.

7. The machine of claim 1 wherein the thru-hole is a cylinder.

8. The machine of claim 1 wherein the surface of the plenum opposite the hermetic window is non-planar.

9. A machine comprising:
a source of light that is characterized by a wavelength λ;
a plenum comprising a plurality of thru-holes and a plurality of gas shafts, wherein each of the plurality of thru-holes comprises a first opening and a second opening, and wherein each of the plurality of thru-holes intersects at least one of the plurality of gas shafts;
a hermetic window that:
(i) is substantially transparent to light characterized by the wavelength λ, and
(ii) substantially prevents the gas from flowing through the first opening of the each of the plurality of thru-holes; and
an optical instrument that directs the light from the source through the hermetic window, through the first opening of each of the plurality of thru-holes, and through the second opening of each of the plurality of thru-holes.

10. The machine of claim 9 wherein the machine is configured to heat a patch of fabric that is impregnated with a thermoplastic, and
wherein the temperature of the plenum remains below the resin softening point of the thermoplastic.

11. The machine of claim 9 wherein the average temperature of the plenum is below 200° Celcius.

12. The machine of claim 9 further comprising:
a vacuum for evacuating, via the gas shaft, the plurality of thru-holes of the gas.

13. The machine of claim 9 further comprising:
a pump for pressurizing, via the gas shaft, the plurality of thru-holes with the gas.

14. The machine of claim 13 wherein the machine is configured to heat a patch of fabric that is impregnated with a thermoplastic, and
wherein the temperature of the gas is below the resin softening point of the thermoplastic.

15. The machine of claim 9 wherein at least one of the plurality of thru-holes is a cylinder.

16. The machine of claim 9 wherein the surface of the plenum opposite the hermetic window is non-planar.

17. The machine of claim 9 wherein the plurality of thru-holes are arranged in an orthogonal array.

18. The machine of claim 9 wherein the plurality of thru-holes are arranged in an hexagonal array.
